(19) United States
(12) Patent Application Publication
(10) Pub. No.: US 2026/0328610 A1
(43) Pub. Date: Oct. 22, 2026

(54) METHODS AND SYSTEMS FOR AUTOMATIC WATER DISPENSER CONTROL USING ACOUSTIC RESONANCE

(71) Applicant: Robert Bosch GmbH, Stuttgart (DE)

(72) Inventor: Kenneth WOJCIECHOWSKI, Cupertino, CA (US)

(21) Appl. No.: 19/185,376

(22) Filed: Apr. 22, 2025

(51) Int. Cl. G01F 23/296; B67D 1/08; B67D 1/12; G05B 13/02

(52) U.S. Cl. CPC G01F 23/2966; B67D 1/0888; B67D 1/1238; G05B 13/028; B67D 2001/1259

(57) ABSTRACT

Methods and systems for water dispenser control utilizing acoustic resonance addresses the challenge of detecting liquid fill levels without direct observation or complex sensors. The system comprises a microphone that captures acoustic signals and converts them to electrical signals, wherein frequency chirp profiles are extracted to determine the fill levels. Accordingly, control signals are generated to cease dispensing when near-full conditions are detected, thereby enhancing performance in integrated refrigerator water dispensers.

### TECHNICAL FIELD

The present disclosure generally relates to consumer appliance technologies. In specific embodiments, the present disclosure relates to automatic water dispenser control systems utilizing acoustic resonance for liquid fill detection.

### BACKGROUND

In modern consumer appliances, precise detection of liquid fill levels plays a significant role in ensuring efficient operation and optimal user satisfaction. Current systems predominantly utilize direct sensing techniques—employing optical, ultrasonic, or radar-based sensors—to monitor the liquid level within a container. Although these methods are typically effective under ideal conditions by measuring the distance to the liquid surface, they rely on unobstructed access or clear optical paths. However, such approaches may be challenged by factors including container opacity, nonstandard shapes, or design constraints, which can necessitate the incorporation of additional components and lead to increased costs and complexity in both product design and maintenance.

In some instances, alternative solutions have sought to infer liquid levels indirectly by monitoring variations in select measurable physical parameters during the filling process. Accordingly, while these indirect methods can circumvent some limitations associated with direct observation, they are frequently affected by environmental variability and require extensive calibration across diverse container types and operating conditions. These challenges underscore a continuing need for a robust yet cost-effective approach that is capable of reliably detecting liquid fill conditions without depending on direct observation or intrusive sensor placements.

### SUMMARY

In an embodiment, a method for controlling a water dispensing device during a filling operation comprises: receiving, from a microphone positioned near a container, an acoustic signal as liquid is dispensed from the water dispensing device into the container; converting, at a processor, the acoustic signal into an electrical signal that is representative of acoustic activity generated during the filling operation; extracting, from the electrical signal, a frequency chirp profile corresponding to a resonant frequency of an air cavity defined between a liquid surface and an upper opening of the container during the filling operation; comparing the extracted frequency chirp profile to a plurality of stored frequency chirp profiles indicative of a near-full condition of the container; and in response to the extracted frequency chirp profile matching at least one of the plurality of stored frequency chirp profiles, generating a control signal to terminate the filling operation to prevent additional liquid from entering the container.

In an embodiment, an appliance such as a refrigerator comprises: a water dispenser configured to dispense water to a container; a microphone located near the water dispenser and configured to capture an acoustic signal generated during a container-filling operation; and a processor programmed to (i) convert the acoustic signal into an electrical signal, (ii) extract a frequency chirp profile from the electrical signal, wherein the frequency chirp profile is associated with a frequency chirp that is produced during the container-filling operation, (iii) based on the frequency chirp profile, issue a control signal to cease water from dispensing from the water dispenser.

In an embodiment, a non-transitory computer-readable medium stores instructions that, when executed by a processor, cause the processor to perform steps comprising: receiving an acoustic signal generated during a container-filling operation from a microphone positioned near a water dispenser; converting the acoustic signal into an electrical signal representative of acoustic activity during the filling operation; extracting a frequency chirp profile from the electrical signal, wherein the frequency chirp profile is associated with a resonant frequency produced during the container-filling operation; comparing the extracted frequency chirp profile to a plurality of stored frequency chirp profiles indicative of a near-full condition of the container; determining a match between the extracted frequency chirp profile and one of the stored frequency chirp profiles; and generating a control signal to cease water dispensing from the water dispenser based on the match.

### BRIEF DESCRIPTION OF THE DRAWINGS

FIG. 1 is a view of an appliance with an integrated water dispenser, according to an embodiment.

FIG. 2 is a schematic block diagram view of the integration of a fill detection system within an appliance for controlling a water dispenser, according to an embodiment.

FIG. 3 is a graph view of a comparison between measured and stored frequency chirp profiles for liquid fill detection, according to an embodiment.

FIG. 4 is a schematic flow chart diagram view of a method for detecting a near-full condition in a water container using acoustic signals, according to an embodiment.

FIG. 5 shows a system for training a neural network, according to an embodiment.

FIG. 6 depicts a schematic diagram of an interaction between a computer-controlled machine and a control system, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Consumer appliances such as refrigerators allow for a user to fill a drinking cup, glass, or other water container with water dispensed from the refrigerator. Detecting the fill level of water is crucial for efficient operation and user satisfaction. Traditional systems often use sensors like optical or ultrasonic devices to measure the water level in the container by detecting the distance to the liquid surface. By using these sensors, the appliance can detect when the container is near filled, and can automatically shut off the water dispenser. These methods work well when conditions are perfect, but they can struggle with issues like containers that are opaque or have unusual shapes. These challenges can lead to the need for extra components, increasing the cost and complexity of the product. Moreover, these systems often require a direct line of sight to the liquid, which isn't always possible.

Some alternative methods try to estimate liquid levels by observing changes in certain physical parameters during the filling process. While these methods can avoid some of the problems of direct observation, they are often affected by changes in the environment and need a lot of calibration for different types of containers and conditions. This highlights the need for a reliable and cost-effective way to detect liquid fill levels without needing direct observation or complex sensor setups.

The present disclosure offers solutions by using a novel approach to detect when a liquid bottle is full (or near-full), based on the sound it makes as it fills. According to embodiments, the systems and methods herein use a microphone and algorithms or models to analyze the sound, similar to how a musical instrument's pitch changes. As the bottle fills, the frequency of the sound increases, indicating the fill level. By analyzing how the frequency of the sound changes over time, the controller in the appliance can automatically shut off the water dispenser. This approach is cost-effective and versatile, making it suitable for appliances like refrigerators. It reduces the need for clear containers or direct observation, cutting costs and increasing flexibility. It also offers an alternative to direct measurement of the water level, instead indirectly measuring the water level.

As used herein, an “appliance” refers to a device or machine designed to perform a specific function, typically for domestic use, such as cooking, cleaning, or food preservation. Common examples include refrigerators, ovens, washing machines, and dishwashers. Appliances are often powered by electricity or gas and are integral to modern household operations, providing convenience and efficiency in everyday tasks.

As used herein, a “container,” in the context of filling water at the appliance, refers to any receptacle designed to hold liquid during a dispensing operation. This includes, but is not limited to, drinking cups, glasses, water bottles, or any other vessel capable of receiving and storing water dispensed from the appliance. Containers can vary in size, shape, and material, and are positioned beneath the water dispenser to receive the dispensed water during the filling process.

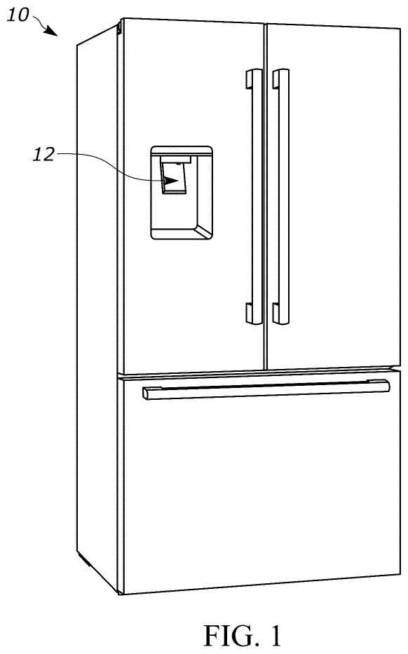

FIG. 1 is an example of such an appliance 10, namely a refrigerator. The present disclosure is not limited to a refrigerator, nor the refrigerator shown in FIG. 1. For example, while the refrigerator shown herein is a consumer-grade French-door refrigerator with a freezer beneath, the refrigerator 10 may be a side-by-side refrigerator, a top-freezer refrigerator, a bottom-freezer refrigerator, a compact refrigerator, or the like. Moreover, the appliance may also be an industrial-grade refrigerator. In other embodiments, the appliance may be a water cooler designed to provide chilled or ambient drinking water, typically from a large refillable bottle or a direct water line.

The appliance 10 has an integrated water dispenser 12. The water dispenser 12 can be positioned on the exterior to allow easy access for users. In other embodiments, the water dispenser 12 is on the inside of the refrigerator door, accessible once a user has opened the refrigerator. The water dispenser 12 is configured to dispense water into a container placed beneath the dispenser. In one embodiment, the water dispenser 12 may include a sensor that detects the presence of a container and automatically initiates water flow, ensuring hands-free operation and reducing the risk of spills. In another embodiment, the dispenser could feature a manual lever or button that users press to initiate the water flow, providing a simple and intuitive interface. Additionally, the dispenser might incorporate a digital interface with programmable settings, allowing users to select specific water volumes or temperatures for customized dispensing.

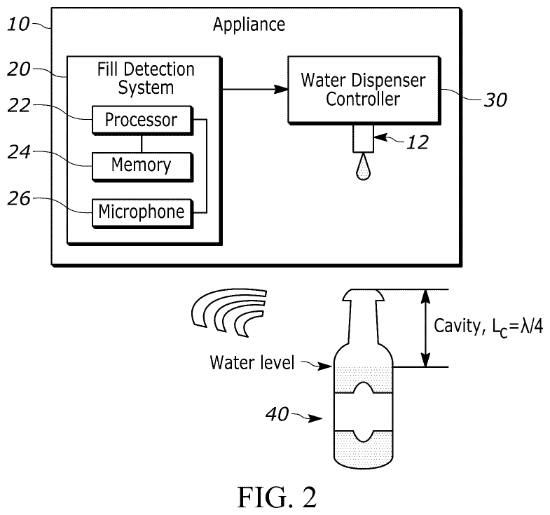

FIG. 2 is a schematic block diagram of the appliance 10, showing the appliance equipped with a fill detection system 20 for detecting the fullness of a water container, and a water dispenser controller 30 for controlling operation of the water dispenser. In general, the appliance 10 integrates the fill detection system 20, which comprises a processor 22, a memory 24, and a microphone 26, with the water dispenser controller 30 to manage the operation of a water dispenser 12. Dispensing of water into a container 40 is monitored by the fill detection system 20 to determine the fill level based on acoustic signals, and command the water dispenser controller 30 to act accordingly.

The processor 22 serves as a central component of the fill detection system 20, handling the processing of acoustic signals captured by the microphone 26. As will be described below, the processor 22 converts these signals into electrical signals and extracts frequency chirp profiles that indicate the resonant frequency of the air cavity within the container 40. The processor 22 is connected to the memory 24, which stores instructions for the processor to execute the processing on the acoustic signals.

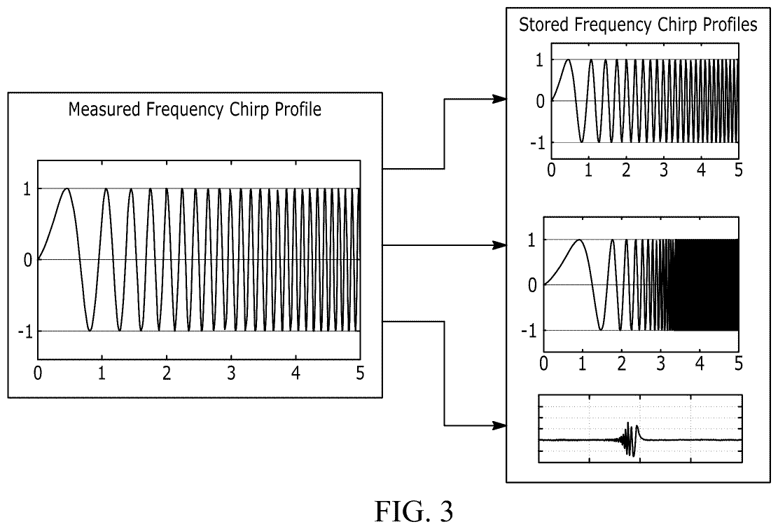

The memory 24 can also function as a storage medium within the fill detection system 20, containing a database of stored frequency chirp profiles (see FIG. 3) that indicate a near-full condition of the container 40. This stored data is important for the processor 22 to compare against the extracted frequency chirp profiles, facilitating accurate detection of the fill level. Moreover, to optimize memory usage, the stored chirp profiles can be compressed, represented by parameters of mathematical functions, or integrated into the trained AI model weights. This approach not only conserves storage space but also enhances the efficiency of data retrieval and processing. Additionally, the system can perform a calibration process, allowing it to adapt to specific environmental conditions and container characteristics. In AI terms, this calibration can be considered as “learning on the edge,” where the edge refers to the refrigerator itself. By continuously updating and refining the stored chirp profiles based on real-time data, the system ensures accurate detection of the fill level, facilitating precise control over the water dispensing operation. This dynamic learning capability enables the fill detection system 20 to maintain high performance and reliability across diverse scenarios.

The microphone 26 is positioned near the container 40 to capture acoustic signals generated during the filling operation. These signals are necessary for the fill detection system 20 to analyze the sound characteristics and determine the resonant frequency, which changes as the container 40 fills with water.

The water dispenser controller 30 is responsible for managing the operation of the water dispenser 12, ensuring precise control over the dispensing process. Upon receiving a control signal from the processor 22, the water dispenser controller 30 can initiate water flow, allowing the user to fill the container 40. Additionally, the controller 30 can terminate the water dispensing operation to prevent overflow once the container 40 is detected to be near full. The water dispenser controller 30 may include or communicate with various components such as a solenoid valve, which opens and closes to regulate water flow, or a motorized actuator that adjusts the position of a mechanical lever to control dispensing. In some embodiments, the controller 30 might incorporate electronic circuitry that interfaces with the processor 22 to execute commands based on real-time data analysis, ensuring efficient and safe operation of the water dispenser 12.

The water dispenser 12 is a component of the appliance 10 that facilitates the dispensing of water into the container 40. The operation is managed by the water dispenser controller 30, which ensures that the dispensing process is halted at the appropriate time based on the fill level detected by the fill detection system 20.

The container 40 is the receptacle into which water is dispensed from the water dispenser 12. As will be further discussed, the fill detection system 20 monitors the acoustic signals associated with the filling operation to determine the resonant frequency of the air cavity above the water level, which is indicative of the container's fill status.

Before describing additional detail about the operation of the fill detection system 20, it should be understood that references to “processor,” “controller,” or “system” may refer to, or be part of, or include processor hardware (shared, dedicated, or group) that executes code and memory hardware (shared, dedicated, or group) that stores code executed by the processor hardware. The code is configured to provide the features of the controller and systems described herein. In one example, the controller may include a processor (e.g., processor 22), memory (e.g., memory 24), and non-volatile storage. The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory may include a single memory device or a plurality of memory devices including, but not limited to, random access memory (“RAM”), volatile memory, non-volatile memory, static random-access memory (“SRAM”), dynamic random-access memory (“DRAM”), flash memory, cache memory, or any other device capable of storing information. The non-volatile storage may include one or more persistent data storage devices such as a hard drive, optical drive, tape drive, non-volatile solid-state device, or any other device capable of persistently storing information. The processor may be configured to read into memory and execute computer-executable instructions embodying one or more software programs residing in the non-volatile storage. Programs residing in the non-volatile storage may include or be part of an operating system or an application, and may be compiled or interpreted from computer programs created using a variety of programming languages and/or technologies, including, without limitation, and either alone or in combination, Java, C, C++, C #, Objective C, Fortran, Pascal, Java Script, Python, Perl, and PL/SQL. The computer-executable instructions of the programs may be configured, upon execution by the processor, to cause the water dispenser controller 30 to cease dispensing of water based upon a determination that the container 40 is at a near-full condition based upon the detected sound emitted during the filling process, for example.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied on a tangible medium, e.g., one or more modules of computer program instructions, encoded on one or more computer storage media for execution by, or to control the operation of, a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate components or media (e.g., multiple CDs, disks, or other storage devices). The computer storage medium may be tangible and non-transitory.

A computer program (also known as a program, software, software application, script, or code) can be written in any form of programming language, including compiled languages, interpreted languages, declarative languages, and procedural languages, and the computer program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, libraries, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a field programmable gate array (“FPGA”) or an application specific integrated circuit (“ASIC”). Such a special purpose circuit may be referred to as a computer processor even if it is not a general-purpose processor.

According to embodiments, the fill detection system 20 operates by capturing and analyzing acoustic signals generated during the filling operation of the container 40. The microphone 26, strategically positioned near the container 40, detects the sound produced as water is dispensed into the container. This sound is characterized by a frequency chirp, which is a continuous shift in frequency resulting from the changing resonant frequency of the air cavity above the water level. The resonant frequency can be approximated using the formula f₀=ₛv/(4×L_{C}), where f₀ is the fundamental resonant frequency, ₛv is the speed of sound, and L_{C} is the effective length of the air cavity. As the container fills, the length L_{C} decreases, causing the resonant frequency to increase, which is detected as a frequency chirp.

The processor 22 is programmed to convert the acoustic signals captured by the microphone 26 into electrical signals. This can involve several steps. For example, in embodiments, initially the microphone 26 detects the sound waves generated during the filling operation of the container 40. These sound waves, characterized by varying frequencies and amplitudes, are transformed into analog electrical signals by the microphone. The processor 22 then receives these analog signals and performs an analog-to-digital conversion, translating the continuous analog signals into discrete digital data that can be processed and analyzed.

Once the acoustic signals are digitized, the processor 22 can employ signal processing techniques to extract meaningful information from the digital data. This can involve filtering out noise and isolating the frequency components that correspond to the resonant frequency of the air cavity within the container 40. The processor 22 can use algorithms, such as Fast Fourier Transform (FFT), to analyze the frequency spectrum and identify the frequency chirp profile, which is indicative of the changing resonant frequency as the container fills. This digital representation of the acoustic activity allows the processor 22 to accurately monitor the fill level and make real-time decisions based on the detected sound signatures.

The extracted frequency chirps provide valuable information about how full a container is by reflecting changes in the resonant frequency of the air cavity above the liquid. As the container fills with water, the air cavity becomes smaller, causing the resonant frequency to increase. This increase in frequency is detected as a frequency chirp, which is a continuous shift in frequency over time.

The relationship between the frequency chirp and the fill level can be generally linear, meaning that as the container 40 fills, the frequency increases at a consistent rate. By monitoring this change in frequency, the system can determine how close the container is to being full. When the frequency reaches a certain threshold, it indicates that the container is nearly full, prompting the system to send a signal to stop the water flow and prevent overflow. This method allows for an indirect yet effective way to gauge the fill level without needing direct observation of the liquid.

Once the frequency chirp is extracted, the fill detection system 20 can determine what frequency should cause the water dispenser controller 30 to cease water from being dispensed from the dispenser 20. In one embodiment, the fill detection system 20 utilizes a database of stored frequency chirp profiles within the memory 24. See, for example, FIG. 3 which shows a schematic of a comparison of a currently-measured frequency chirp profile with a plurality of stored frequency chirp profiles stored in storage or memory 24. These stored profiles are pre-recorded and associated with various stages of container fill levels, including a near-full condition. Each stored profile can be tagged with a flag indicating the frequency threshold that corresponds to a near-full state. During the filling operation, the processor 22 continuously extracts the frequency chirp profile from the electrical signals generated by the microphone 26. The processor 22 then compares the real-time extracted profile to the stored profiles in the database. When a match is found between the extracted profile and a stored profile flagged as near-full, the processor 22 generates a control signal to the water dispenser controller 30, instructing it to terminate the water dispensing operation.

In another embodiment, the fill detection system 20 employs a machine learning model to enhance the accuracy of detecting a near-full condition. The machine learning model is trained using historical frequency chirp data, which can include various fill levels and corresponding frequency changes. The model learns to identify patterns in the frequency chirp profile that are indicative of a near-full container. During operation, the processor 22 feeds the extracted frequency chirp profile into the machine learning model, which analyzes the data and predicts the fill level. If the model identifies a pattern that matches the learned near-full condition, it triggers the processor 22 to send a control signal to the water dispenser controller 30 to stop the water flow. More detail about machine learning is provided below.

The training of the machine learning model can involve collecting a comprehensive dataset of frequency chirp profiles associated with different fill levels and container types. This dataset serves as the foundation for training the model to recognize the acoustic patterns that correspond to a near-full condition. Supervised learning techniques can be employed, where the model is provided with labeled data indicating the fill level at various stages. Time-series analysis models, such as recurrent neural networks (RNNs) or long short-term memory (LSTM) networks, are particularly well-suited for this application due to their ability to process sequential data and capture temporal dependencies in the frequency chirp profiles. These models can learn to identify subtle changes in the frequency patterns over time, enabling them to accurately predict when the container is nearing full. Additionally, convolutional neural networks (CNNs) can be used to analyze the frequency spectrum as an image, extracting features that are indicative of the fill level. Once trained, the model can generalize to new, unseen data, allowing it to adapt to different container shapes, sizes, and materials, thereby enhancing the robustness and accuracy of the fill detection system.

In a further embodiment, the fill detection system 20 monitors the rate of change of the frequency chirp profile over time. The processor 22 calculates the derivative of the frequency with respect to time, providing insight into how quickly the resonant frequency is increasing. A rapid rate of change suggests that the container is nearing full, as the air cavity length L_{C} becomes minimal. The processor 22 compares the calculated rate of change to a set of stored rate-of-change patterns in the memory 24. When the rate of change matches a stored pattern indicative of a near-full condition, the processor 22 generates a control signal to the water dispenser controller 30 to cease water dispensing.

In yet another embodiment, the fill detection system 20 utilizes a threshold-based approach. The processor 22 continuously monitors the extracted frequency chirp profile and compares it to a predefined frequency threshold stored in the memory 24. This threshold is calibrated to correspond to a near-full condition of the container. As the frequency chirp profile approaches or exceeds this threshold, the processor 22 determines that the container is nearly full and sends a control signal to the water dispenser controller 30 to halt the water flow, preventing overflow and ensuring efficient operation.

Once the fill detection system 20 determines that the container 40 is near full, it initiates a sequence of actions to ensure the water dispensing operation is halted promptly to prevent overfilling. For example, in embodiments, the processor 22, upon identifying a frequency chirp profile that matches a near-full condition, generates a control signal. This control signal is a digital command that is transmitted through an interface connecting the processor 22 to the water dispenser controller 30. The interface may utilize a wired connection, such as a serial or parallel communication bus, or a wireless protocol, depending on the design of the appliance 10. The control signal contains specific instructions for the water dispenser controller 30 to execute, ensuring that the water flow is stopped immediately.

The water dispenser controller 30, upon receiving the control signal from the processor 22, activates its internal mechanisms to cease the water dispensing operation. This may involve closing a solenoid valve that regulates the flow of water from the reservoir to the dispenser outlet. The controller 30 may also engage a motorized actuator to reposition a mechanical lever or switch that physically interrupts the water flow. In some embodiments, the controller 30 includes feedback mechanisms that confirm the successful cessation of water flow, such as sensors that detect the valve's position or the absence of water movement. This feedback is relayed back to the processor 22, which can log the event and ensure that the system is ready for the next dispensing operation. By coordinating these actions, the fill detection system 20 and the water dispenser controller 30 work in tandem to provide a reliable and efficient solution for preventing overfilling, enhancing the overall functionality and safety of the appliance 10.

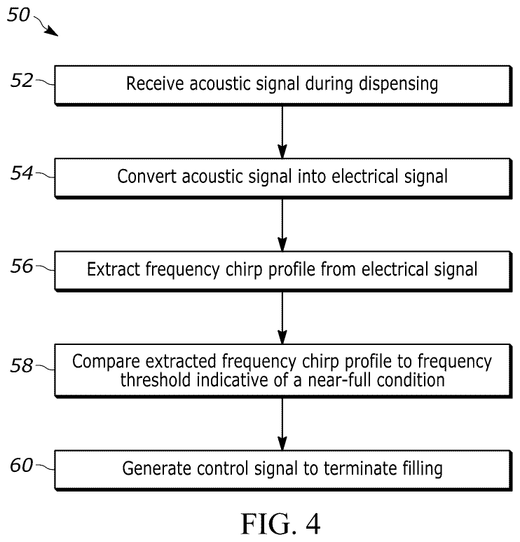

The method depicted in FIG. 4 illustrates a method 50 for method for controlling a water dispensing device during a filling operation, according to an embodiment. The method 50 can be executed by one or more processors described herein (e.g., processor 22 within the fill detection system 20). This method is designed to ensure efficient and safe operation of the water dispenser 12 by preventing overfilling of the container 40.

In embodiments, the method 50 is initiated based upon the user activating the water dispenser 12, such as by pressing a fill button.

The process begins with step 52, where the system receives an acoustic signal during the dispensing operation. For example, the microphone 26, positioned near the container 40, captures the sound generated as water is dispensed into a container 40. This acoustic signal contains the frequency chirp indicative of the resonant frequency of the air cavity within the container 40. If the processor 22 identifies a frequency chirp, it confirms that the container is present and the filling process is underway.

In embodiments, if no frequency chirp is detected, the algorithm infers that a container may not be present beneath the dispenser, or that the container is improperly positioned. In such cases, the processor 22 can generate a control signal to the water dispenser controller 30 to halt the water flow, preventing unnecessary dispensing and potential spillage. This embodiment ensures that the fill detection system 20 operates efficiently by verifying the presence of a container before continuing the dispensing process. Assuming there is indeed a container present that is causing a frequency chirp to be detected, the method can proceed to step 54.

In step 54, the processor 22 converts the acoustic signal into an electrical signal. This conversion involves transforming the analog sound waves captured by the microphone 26 into digital data that can be processed and analyzed. The electrical signal represents the acoustic activity during the filling operation, providing a basis for extracting meaningful information about the container's fill status. The processor 22 utilizes signal processing techniques, such as FFT, to delineate the frequency spectrum and isolate the frequency chirp profile.

Step 56 involves extracting the frequency chirp profile from the electrical signal. In embodiments, the processor 22 analyzes the digital data to identify the frequency chirp, which corresponds to the resonant frequency of the air cavity above the liquid surface in the container 40. This profile is indicative of the changing fill level, as the resonant frequency increases with the decreasing air cavity length L_{C}. The extracted frequency chirp profile provides a real-time representation of the container's fill status, allowing the system to monitor the progression of the filling operation.

In step 58, the extracted frequency chirp profile is compared to a frequency threshold indicative of a near-full condition. In embodiments, the processor 22 evaluates the profile against stored frequency thresholds or patterns in the memory 24, which signify a near-full state of the container 40. As explained above, various embodiments can be employed for this comparison. For example, some embodiments include the use of machine learning models trained on historical frequency chirp data to predict the fill level. Alternatively, the system may utilize a database of stored frequency chirp profiles tagged with flags indicating near-full conditions, or monitor the rate of change of the frequency chirp over time to identify rapid increases that suggest the container is nearing full.

Finally, in step 60, the processor 22 generates a control signal to terminate the filling operation. Upon determining that the frequency chirp profile matches the near-full condition, the processor 22 sends a control signal to the water dispenser controller 30. This signal instructs the controller to cease water dispensing, preventing overflow and ensuring efficient operation. As explained above, the water dispenser controller 30 may employ various mechanisms, such as closing a solenoid valve or engaging a motorized actuator, to halt the water flow.

It should be understood that the final fill level detected by the fill detection system 20 may be influenced by variations in the speed of sound, which can fluctuate due to changes in temperature and atmospheric pressure. These environmental factors can cause slight deviations in the resonant frequency calculations, as the speed of sound directly affects the determination of the air cavity length L_{C} within the container 40. However, it is important to note that these variations typically result in an uncertainty of less than 1 cm in the fill level measurement, which is within acceptable limits for many applications. The system is designed to accommodate these minor discrepancies, ensuring reliable and accurate detection of near-full conditions. By accounting for these environmental influences, the fill detection system 20 maintains its effectiveness across a range of operating conditions, providing consistent performance.

It should be understood that, in addition to frequency chirps, other sound characteristics such as loudness and power relative to frequency can be leveraged to distinguish the material and shape of the container. For instance, the material of the container affects sound damping, influencing the power of the emitted sound. Furthermore, the frequency of a closed pipe, akin to the air cavity in a container, can vary based on the size of its opening, while the shape of the container can accentuate or diminish the harmonics, or timbre, of the sound produced. This means that the harmonic content of the sound can provide valuable insights into the shape of the container. Given that the sound signature emitted from a container can vary significantly due to factors like material, shape, and environmental noise, a more sophisticated algorithm may be required. Such an algorithm would analyze the spectrum and power of the emitted sound to accurately infer container characteristics, thereby enhancing the precision and adaptability of the fill detection system 20 across diverse conditions.

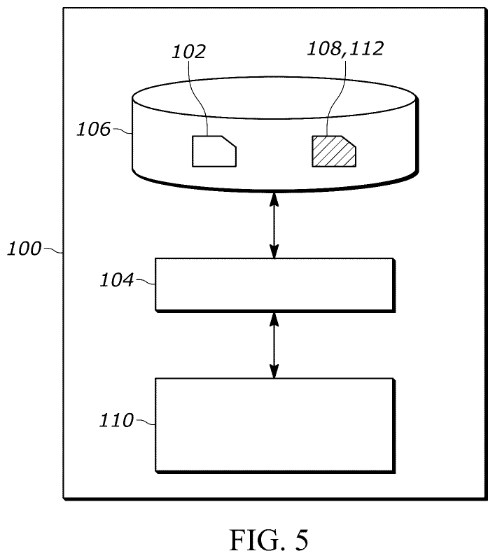

As mentioned above, machine learning can be employed. Therefore, a brief description of machine learning models and training will now be provided. FIG. 5 shows a system 100 for training a neural network, e.g. a deep neural network. The system 100 may comprise an input interface for accessing training data 102 for the neural network. For example, as illustrated in FIG. 5, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network; this data may also be referred to as trained model data 112. For example, as also illustrated in FIG. 5, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 5 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

The structure of the system 100 is but one example of a system that may be utilized to train the machine-learning models described herein. In application, the structure of the system 100 can be utilized to train machine learning models specifically configured to detect when the container 40 is near full. By leveraging the system's ability to process and analyze historical frequency chirp data, the trained model can accurately identify patterns indicative of a near-full condition, thereby enhancing the precision and reliability of the fill detection system 20.

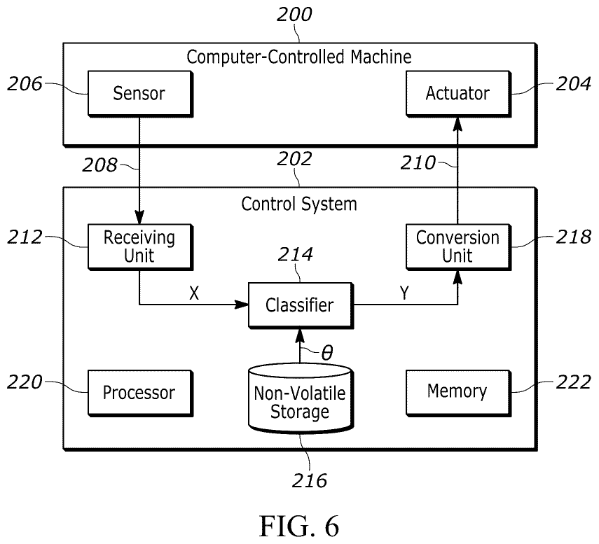

The machine-learning models and other control algorithms described herein can be used in many different applications, and tuned according to various scenarios. Exemplary structure used for using these such models and algorithms is shown in FIG. 6.

FIG. 6 depicts a schematic diagram of an interaction between a computer-controlled machine 200 and a control system 202. In general, the computer-controlled machine 200 can include the appliance 10 (e.g., its microphone and water shut-off components), and control system 202 can include fill detection system 20. Computer-controlled machine 200 includes actuator 204 and sensor 206. Sensor 206 may include the microphone 26 and any associated processor for pre-processing or processing of the audio, including encoding the sensed condition into sensor signals 208, and transmitting sensor signals 208 to control system 202.

Control system 202 is configured to receive sensor signals 208 from computer-controlled machine 200. As set forth below, control system 202 may be further configured to compute actuator control commands 210 depending on the sensor signals and to transmit actuator control commands 210 to actuator 204 of computer-controlled machine 200.

As shown in FIG. 6, control system 202 includes receiving unit 212. Receiving unit 212 may be configured to receive sensor signals 208 from sensor 206 and to transform sensor signals 208 into input signals x. In an alternative embodiment, sensor signals 208 are received directly as input signals x without receiving unit 212. Each input signal x may be a portion of each sensor signal 208. Receiving unit 212 may be configured to process each sensor signal 208 to product each input signal x. Input signal x may include data corresponding to sound recorded by sensor 506.

Control system 202 can include a classifier 214. Classifier 214 may be configured to classify input signals x into one or more labels using a machine-learning algorithm, such as a neural network described above. The classifier can also implement the other non-machine learning ways of fill detection described above (e.g., compare extracted frequency chirps to stored frequency chirps, perform thresholding analysis, etc.). Classifier 214 is configured to be parametrized by parameters, such as those described above (e.g., parameter θ). Parameters θ may be stored in and provided by non-volatile storage 216. Classifier 214 is configured to determine output signals y from input signals x. Each output signal y includes information that assigns one or more labels to each input signal x, such as the container being near full. Classifier 214 may transmit output signals y to conversion unit 218. Conversion unit 218 is configured to covert output signals y into actuator control commands 210 for shutting off the water dispensing.

Upon receipt of actuator control commands 210 by actuator 204, actuator 204 is configured to execute an action corresponding to the related actuator control command 210. Actuator 204 may include a control logic configured to transform actuator control commands 210 into a second actuator control command, which is utilized to control actuator 204. Actuator 204 can include one or more of the mechanisms described above for starting and/or stopping water flow into the container 40.

As shown in FIG. 6, control system 202 also includes processor 220 and memory 222. Processor 220 may include one or more processors, and may take the form of any of the processors described above (e.g., processor 22). Memory 222 may include one or more memory devices, and may take the form of any of the memory described above (e.g., memory 24). The classifier 214 (e.g., machine-learning algorithms, such as those described above) of one or more embodiments may be implemented by control system 202, which includes non-volatile storage 216, processor 220 and memory 222.

Upon execution by processor 220, the computer-executable instructions of non-volatile storage 216 may cause control system 202 to implement one or more of the machine-learning algorithms and/or methodologies as disclosed herein. Non-volatile storage 216 may also include machine-learning data (including data parameters) supporting the functions, features, and processes of the one or more embodiments described herein.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for controlling a water dispensing device during a filling operation, the method comprising:
receiving, from a microphone positioned near a container, an acoustic signal as liquid is dispensed from the water dispensing device into the container;
converting, at a processor, the acoustic signal into an electrical signal that is representative of acoustic activity generated during the filling operation;
extracting, from the electrical signal, a frequency chirp profile corresponding to a resonant frequency of an air cavity defined between a liquid surface and an upper opening of the container during the filling operation;
comparing the extracted frequency chirp profile to a plurality of stored frequency chirp profiles indicative of a near-full condition of the container; and
in response to the extracted frequency chirp profile matching at least one of the plurality of stored frequency chirp profiles, generating a control signal to terminate the filling operation to prevent additional liquid from entering the container.

2. The method of claim 1, wherein the step of extracting comprises determining a resonant frequency in accordance to f₀=ₛv/(4×L_{C}), wherein ₛv represents the speed of sound and L_{C} represents an effective air cavity length that decreases as the container fills.

3. The method of claim 1, further comprising determining a rate of change of the frequency chirp profile over time, and wherein the step of comparing includes comparing the determined rate of change to a plurality of stored rate-of-change frequencies in a database.

4. The method of claim 3, wherein the plurality of stored rate-of-change frequencies each include a flag indicating associated with a near-full condition, wherein the control signal is generated based upon the flag being associated with the determined rate of change of the frequency chirp profile.

5. The method of claim 1, wherein the step of comparing is performed via a machine learning model trained to predict a near-full container condition based on historical frequency chirp data, and wherein the step of generating the control signal is based on the machine learning model identifying a pattern in the extracted frequency chirp profile indicative of the container being near full.

6. The method of claim 1, further comprising filtering the electrical signal to reduce ambient noise prior to extracting the frequency chirp profile.

7. The method of claim 1, wherein the step of extracting the frequency chirp profile comprises performing a Fast Fourier Transform (FFT) on the electrical signal to delineate the resonant frequency spectrum.

8. An appliance comprising:
a water dispenser configured to dispense water to a container;
a microphone located near the water dispenser and configured to capture an acoustic signal generated during a container-filling operation; and
a processor programmed to (i) convert the acoustic signal into an electrical signal, (ii) extract a frequency chirp profile from the electrical signal, wherein the frequency chirp profile is associated with a frequency chirp that is produced during the container-filling operation, (iii) based on the frequency chirp profile, issue a control signal to cease water from dispensing from the water dispenser.

9. The appliance of claim 8, wherein the processor is programmed to issue the control signal in response to the frequency chirp exceeding a frequency chirp threshold.

10. The appliance of claim 8, wherein the processor is further programmed to (i) determine a rate of change of the frequency chirp, and (ii) issue the control signal in response to the rate of change exceeding a threshold.

11. The appliance of claim 8, wherein the frequency chirp profile is a first frequency chirp profile, wherein the processor is further programmed to (i) compare the first frequency chirp profile to a plurality of stored frequency chirp profiles, (ii) identify one of the plurality of stored frequency chirp profiles as matching to the first frequency chirp profile.

12. The appliance of claim 11, wherein the processor is further programmed to (i) identify a flag in the one of the plurality of stored frequency chirp profiles as indicating a near-full condition, and (ii) issue the control signal in response to the flag matching a current frequency that is being produced during the container-filling operation.

13. The appliance of claim 8, wherein the appliance is a home refrigerator.

14. The appliance of claim 8, wherein the extracting of the frequency chirp
profile comprises determining a resonant frequency in accordance to f₀=ₛv/(4×L_{C}), wherein ₛv represents the speed of sound and L_{C} represents an effective air cavity length that decreases as the container fills.

15. The appliance of claim 8, wherein the processor is further programmed to (i) determine a rate of change of the frequency chirp profile over time, (ii) compare the determined rate of change to a plurality of stored rate-of-change frequencies in a database, and (iii) issue the control signal based on the comparison.

16. A non-transitory computer-readable medium storing instructions that, when executed by a processor, cause the processor to perform steps comprising:
receiving an acoustic signal generated during a container-filling operation from a microphone positioned near a water dispenser;
converting the acoustic signal into an electrical signal representative of acoustic activity during the filling operation;
extracting a frequency chirp profile from the electrical signal, wherein the frequency chirp profile is associated with a resonant frequency produced during the container-filling operation;
comparing the extracted frequency chirp profile to a plurality of stored frequency chirp profiles indicative of a near-full condition of the container;
determining a match between the extracted frequency chirp profile and one of the stored frequency chirp profiles; and
generating a control signal to cease water dispensing from the water dispenser based on the match.

17. The non-transitory computer-readable medium of claim 16, wherein the instructions, when executed by the processor, cause the processor to further perform:
determining a frequency in the one of the stored frequency chirp profiles indicative of a near-full condition;
wherein the generating is in response to the frequency in the one of the stored frequency chirp profiles matching a current frequency during the filling operation.

18. The non-transitory computer-readable medium of claim 16, wherein the comparing is performed via a machine-learning model that has been trained to recognize the near-full condition of the container based on training frequency chirp profiles.

19. The non-transitory computer-readable medium of claim 16, wherein the step of extracting comprises determining a resonant frequency in accordance to f₀=ₛv/(4×L_{C}), wherein ₛv represents the speed of sound and L_{C} represents an effective air cavity length that decreases as the container fills.

20. The non-transitory computer-readable medium of claim 16, wherein the instructions, when executed by the processor, cause the processor to further perform:
determining a rate of change of the frequency chirp profile over time, and wherein the step of comparing includes comparing the determined rate of change to a plurality of stored rate-of-change frequencies in a database;
wherein the generating of the control signal is based on the comparing of the determined rate of change to a plurality of stored rate-of-change frequencies in a database.
